(19) United States
(12) Patent Application Publication
(10) Pub. No.: US 2008/0134840 A1
(43) Pub. Date: Jun. 12, 2008

(54) Screw driver

(75) Inventors: Yoshinori Shibata, Aichi (JP); Koji Tanaka, Aichi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-Shi (JP)

(21) Appl. No.: 12/000,410

(22) Filed: Dec. 12, 2007

(30) Foreign Application Priority Data
Dec. 12, 2006 (JP) 2006-334908

(51) Int. Cl. B25B 17/00; B25B 15/00

(52) U.S. Cl. 81/57.11; 81/436

(57) ABSTRACT

A motor has a motor shaft. An output shaft is provided with a driver bit and movable in an axial direction thereof. A first gear is configured to rotate around a rotary center to transmit rotations of the motor shaft. A second gear has inner teeth. A carrier includes planetary gears each of which is disposed inside the second gear to mesh with the inner teeth. A clutch mechanism is configured to connect or disconnect the carrier and the output shaft in accordance with the movement of the output shaft. The rotations of the first gear is transmitted to the carrier by way of the planetary gears.

### BACKGROUND

The present invention relates to a screw driver which is used for screw fastening.

Japanese Patent Publication No. 1-121179A discloses a screw driver which includes a motor, an output shaft having a clutch mechanism, and an intermediate shaft provided between a motor shaft of the motor and the output shaft so as to extend in parallel with them, wherein a first gear provided in a rear end of the intermediate shaft is meshed with the motor shaft, and a second pinion provided in a front end of the intermediate shaft is meshed with a final gear of the output shaft, so that rotation of the motor shaft can be transmitted to the output shaft at a reduced speed.

In this screw driver, for the purpose of performing two-step speed change of the output shaft, the intermediate shaft can be operated to move back and forth by a shift lever which is provided on a lower face of the housing, and another second pinion meshed with the final gear is rotatably fitted to the intermediate shaft in the rear side of the second pinion. Specifically, when the intermediate shaft is moved forward by the shift lever, the forward second pinion is meshed with the final gear to realize low-speed rotation, and when the intermediate shaft is moved rearward, the front second pinion is meshed with the rear second pinion, whereby the final gear is rotated at high-speed by way of the rear second pinion.

However, in the screw driver in which speed reduction is performed by providing the intermediate shaft as described above, as shown in FIG. 6, for example, a speed reduction mechanism 53 which contains the intermediate shaft, a gear 54 and so on is generally provided so as to protrude from a side face of a housing 50 than a motor shaft 51 and a gear 52 at an output shaft side. For this reason, an overall width is increased, and screwing work in a narrow space is restricted. Particularly, in the screw driver disclosed in the above publication, the shift lever is further provided outside the first gear having a large diameter to perform two-step speed change, and hence, the housing becomes more large-sized, incurring deterioration of workability.

### SUMMARY

It is therefore a first advantageous aspect of the invention to provide a screw driver which is excellent in workability while a compact housing is realized.

It is a second advantageous aspect of the invention to provide a screw driver which is excellent in workability with a two-step speed changing mechanism.

According to one aspect of the invention, there is provided a screw driver, comprising:

a motor, having a motor shaft;

an output shaft, provided with a driver bit and movable in an axial direction thereof;

a first gear, configured to rotate around a rotary center to transmit rotations of the motor shaft;

a second gear, having inner teeth;

a carrier, including planetary gears each of which is disposed inside the second gear to mesh with the inner teeth; and

a clutch mechanism, configured to connect or disconnect the carrier and the output shaft in accordance with the movement of the output shaft, wherein:

the rotations of the first gear is transmitted to the carrier by way of the planetary gears.

With this configuration, a reduction mechanism does not protrude from the side face of the housing, and the two-step speed changing mechanism can be incorporated in the housing with space saving. As the results, the housing can be made compact, and the screwing work can be conducted even in a narrow space, resulting in excellent workability.

The screw driver may further comprises: a housing, having an inner face formed with an engagement member; and an operating member, adapted to be manually operated. Here, the second gear is movable in the axial direction between a first position meshed with the first gear and a second position engaged with the engagement member by the operating member. The second gear rotates around the rotary center together with the first gear and the planetary gears are not allowed to revolve around to revolve around the rotary center when the second gear is placed in the first position, so that the rotations of the first gear is directly transmitted to the carrier. The second gear is not allowed to rotate around the rotary center and the planetary gears are allowed to revolve around the rotary center when the second gear is placed in the second position, so that the rotations of the first gear is reduced and transmitted to the carrier by way of the planetary gears.

The operating member may be a disk-shaped knob. The second gear may be moved between the first position and the second position by turning the knob.

The screw driver may further comprise a pin, formed on an inner face of the knob at an eccentric position relative to a turning center of the knob. The pin may be fitted with a groove formed on a circumferential face of the second gear, so that the second gear is moved in accordance with the turn of the knob.

The screw driver may further comprise an elastic member, urging the second gear toward one of the first position and the second position. A part of a circumferential face of the knob may form a cam face configured to move the second gear against an urging force of the elastic member in accordance with the turn of the knob.

The screw driver may further comprise a pin, formed on an inner face of the operating member and fitted with a groove formed on a circumferential face of the second gear. The second gear may be moved between the first position and the second position by moving the operating member in the axial direction.

With the above configurations, the two-step speed changing mechanism can be rationally constructed with enhanced space saving.

### BRIEF DESCRIPTION OF THE DRAWINGS

FIG. 1 is a section view of a screw driver according to a first embodiment of the invention, showing a state to perform a high-speed mode.

FIG. 2 is a section view of the screw driver, showing a state to perform a low-speed mode.

FIG. 3 is a schematic front view of the screw driver.

FIG. 4 is a section view of a screw driver according to a second embodiment of the invention.

FIG. 5 is a section view of a screw driver according to a third embodiment of the invention.

FIG. 6 is a schematic front view of a related-art screw driver.

### DETAILED DESCRIPTION OF EXEMPLARY EMBODIMENTS

Embodiments of the invention will be described below in detail with reference to the accompanying drawings.

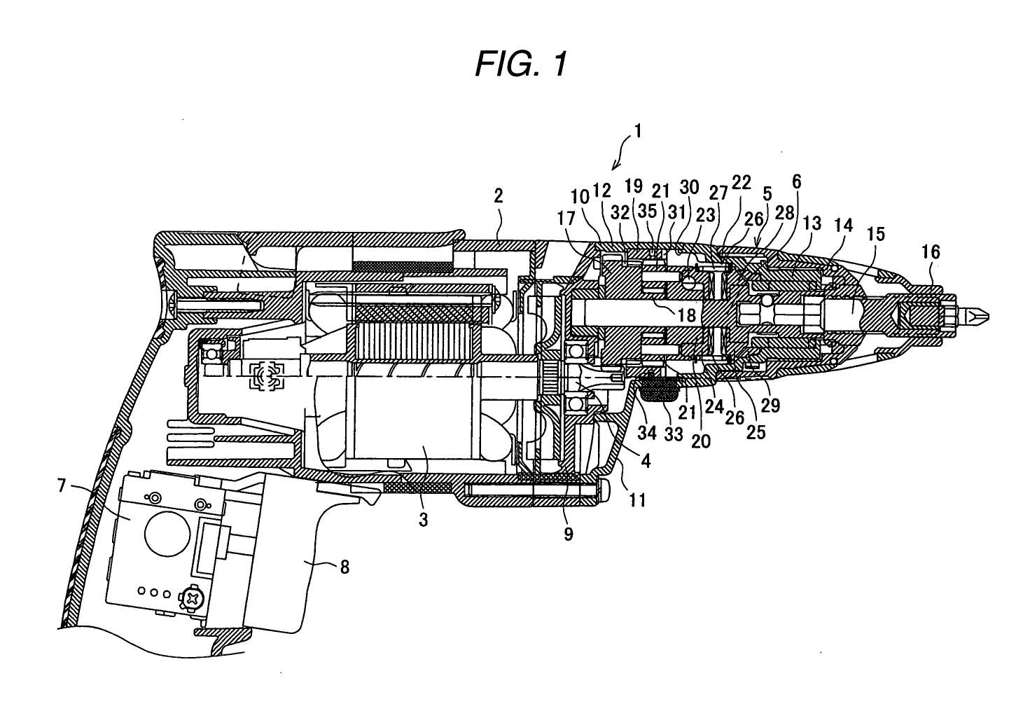

FIG. 1 shows a screw driver according to a first embodiment of the invention. A screw driver 1 includes a main housing 2 which contains a motor 3 in a rear part thereof (at a left side in the drawing), and a front housing 5 which contains an output shaft 6 so as to move back and forth in an axial direction at an upper position than a motor shaft 4 of the motor 3. The front housing 5 is coupled to the main housing 2 at a front side thereof. Reference numeral 7 is a switch of the motor 3, and 8 is a trigger for turning the switch 70N.

In the front housing 5, a gear housing 10 which has a cover part 11 covering a lower half part of a bearing housing 9 and a tubular part 12 formed in an upper part, a front end sleeve 13 which rotatably holds a front end of the output shaft 6, and a lock ring 14 which rotatably holds a driver bit 15 fitted with a front end of the output shaft 6 to restrict an front position of the output shaft 6. The front housing 5 is attached to the bearing housing 9 which rotatably holds the motor shaft 4 and a rear end of the output shaft 6. A stop ring 16 for adjusting a screwing depth is mounted in the front side of the lock ring 14.

Moreover, inside the gear housing 10, a first gear 17 meshed with the motor shaft 4 is rotatably provided on an outer periphery of a rear end of the output shaft 6, as an individual member. In the front side of the first gear 17, a carrier 20 which rotatably holds planetary gears 21 revolving around an output part 18 which is projected forward from the first gear 17 is rotatably provided on an outer periphery of the output shaft 6, as an individual member. A second gear 19 is provided in a tubular part 12 and the carrier 20 is provided at the inner side of the second gear 19. A clutch mechanism 22 is provided in the front side of the carrier 20.

In the clutch mechanism 22 having a known structure, a movable clutch 24 is rotatably provided on an outer periphery of the output shaft 6 as an individual member and coupled to a front part of the carrier 20. A fixed clutch 25 is integrally fixed to the output shaft 6 in the front side of the movable clutch 24. Steel balls 23 are interposed between the movable clutch 24 and the carrier 20. Clutch claws 26 to be meshed with each other are respectively projected from opposing faces of the two clutches 24, 25. Further, a coil spring 27 is interposed between the two clutches 24, 25, whereby in the ordinary state, the fixed clutch 25 is urged forward so that the fixed clutch 25 is separated from the movable clutch 24 and the front end of the output shaft 6 comes into contact with the lock ring 14. In this state, a bevel gear 28 formed on a front face of the fixed clutch 25 is engaged with an engaging ring 29 which is fixed to an inner face of the front end sleeve 13 thereby to restrict the rotations of the fixed clutch 25 and the output shaft 6.

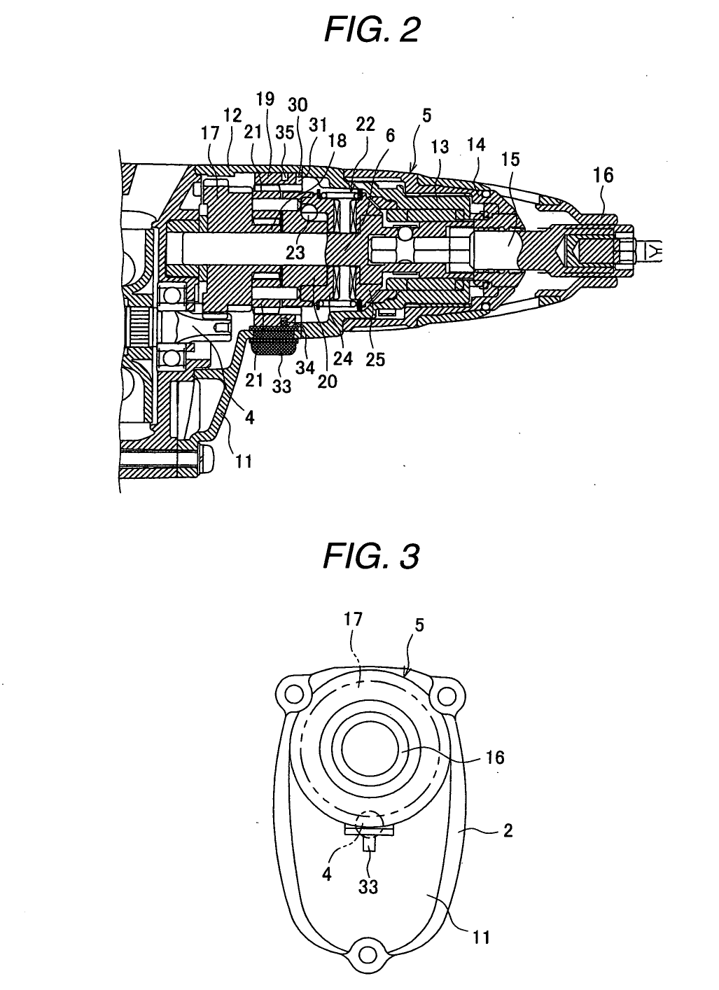

In this structure, the second gear 19 can rotate inside the tubular part 12 of the gear housing 10 and can move back and forth in the axial direction (between a front position and a rear position). On a front end face of the second gear 19, there is formed a stopper claw 31 which can be locked to a locking part 30 formed at a rear end of the front end sleeve 13. Therefore, at the front position of the second gear 19, the rotation is restricted by lock between the stopper claw 31 and the locking part 30, as shown in FIG. 2, thereby permitting the planetary gears 21 to revolve (low-speed mode). On the other hand, at the rear position of the second gear 19 as shown in FIG. 1, internal teeth of the second gear 19 are meshed with teeth 32 which are formed on an outer periphery of a front part of the first gear 17, whereby the revolution of the planetary gears 21 is restricted and the first gear 17 is directly connected to the carrier 20 (high-speed mode). The front and rear positions of the second gear 19 are operated by a disc-shaped knob 33 which is provided on a lower face of the tubular part 12, as an operating member. Specifically, a pin 34 which is uprightly provided at an eccentric position on an upper face of the knob 33 is engaged with a groove 35 which is formed in a circumferential direction on an outer periphery of the second gear 19. The second gear 19 moves back and forth according to a moving amount of the pin 34 in the front-rear direction following the turn of the knob 33.

In the screw driver 1 having the above described structure, the second gear 19 is moved to the rear position by turning the knob 33, as shown in FIG. 1, and the high-speed mode is selected. In this high-speed mode, when the screw driver 1 is pressed forward having a distal end of the driver bit 15 engaged with a screw head, the driver bit 15 and the output shaft 6 relatively retreat inside the front housing 5 against urging force of the coil spring 27, whereby the fixed clutch 25 is separated from the engaging ring 29 to be meshed with the movable clutch 24. In this state, by operating the trigger 8 to actuate the motor 3, rotation speed of the motor shaft 4 is reduced by the first gear 17, and the rotation of the first gear 17 is directly transmitted to the carrier 20. As the results, rotation of the carrier 20 at high speed is transmitted to the movable clutch 24 by way of the steel balls 23, and then, transmitted to the output shaft 6 and the driver bit 15 by way of the fixed clutch 25 which is integrally meshed with the movable clutch 24.

On the other hand, when the motor 3 is actuated in a state that the second gear 19 is moved to the front position to select the low-speed mode by turning the knob 33 as shown in FIG. 2, the rotation speed of the motor shaft 4 is reduced by the first gear 17, and transmitted to the carrier 20, after the speed has been further reduced through revolution of the planetary gears 21 at the inside of the second gear 19 following rotation of the output part 18 of the first gear 17. As the results, the rotation of the carrier 20 at low speed is transmitted to the movable clutch 24 by way of the steel balls 23, and further transmitted to the output shaft 6 and the driver bit 15 by way of the fixed clutch 25.

In both the high-speed mode and the low-speed mode, as the screwing operation proceeds, the screw driver 1 moves forward. When the stop ring 16 comes into contact with a face to be screwed in, forward movement of the screw driver 1 will stop, and only the output shaft 6 moves forward while the screwing operation is continued. The fixed clutch 25 is separated from the movable clutch 24 by this forward movement at the final screwing, whereby the rotation of the output shaft 6 will stop.

As described the above, the carrier 20 provided with the planetary gears 21 capable of revolving around the output part 18 of the first gear 17 at the inside of the second gear 19 is interposed between the first gear 17 and the clutch mechanism 22. The second gear 19 is provided so as to rotate at the inside of the front housing 5, and so as to move back and forth between the rear position at which it is engaged with the output part 18 to directly connect the first gear 17 to the carrier 20 and the front position at which it is separated from the output part 18 to be locked to the locking part 30 to restrict the rotation. The knob 33 for moving the second gear 19 between the back and forth positions is provided on the front housing 5. As the results, the speed reduction mechanism will not protrude from the side face, as shown in FIG. 3, and the two-step speed changing mechanism can be incorporated with space saving. In this manner, the front housing 5 can be made compact, and hence, screwing work can be conducted even in a narrow space, resulting in excellent workability.

Moreover, since the second gear 19 is moved back and forth by turning the disk-shaped knob 33, it is possible to rationally construct the two-step speed changing mechanism with enhanced space saving.

The operating member for moving the second gear back and forth is not limited to the above described configuration, but the operating member may be provided on an upper face or a side face of the front housing.

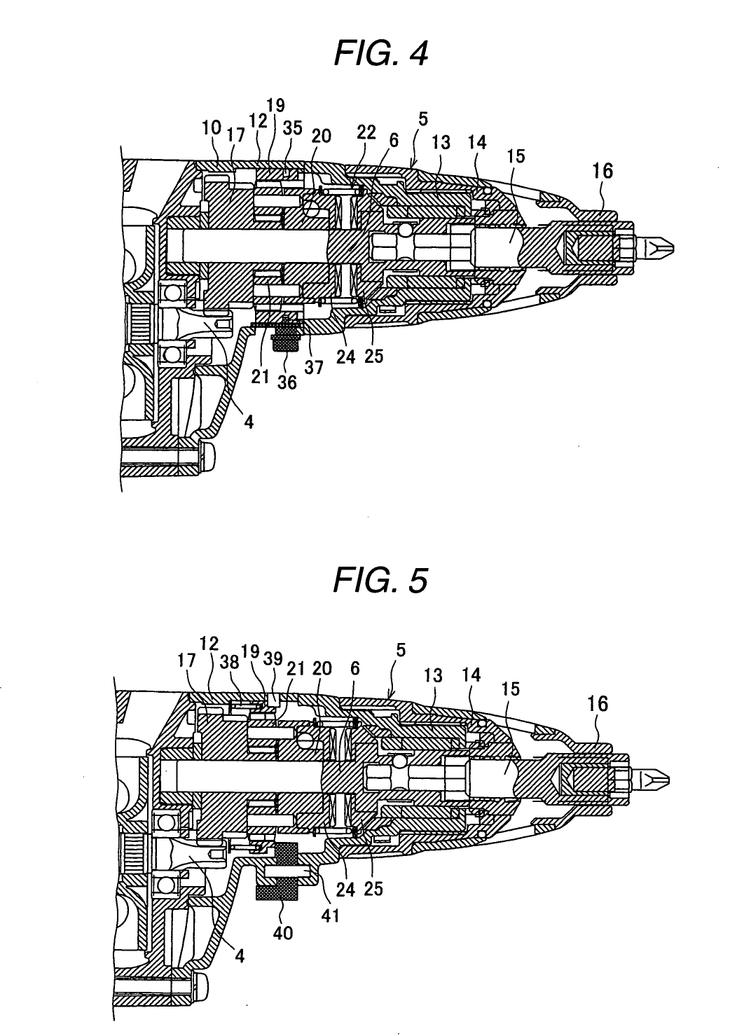

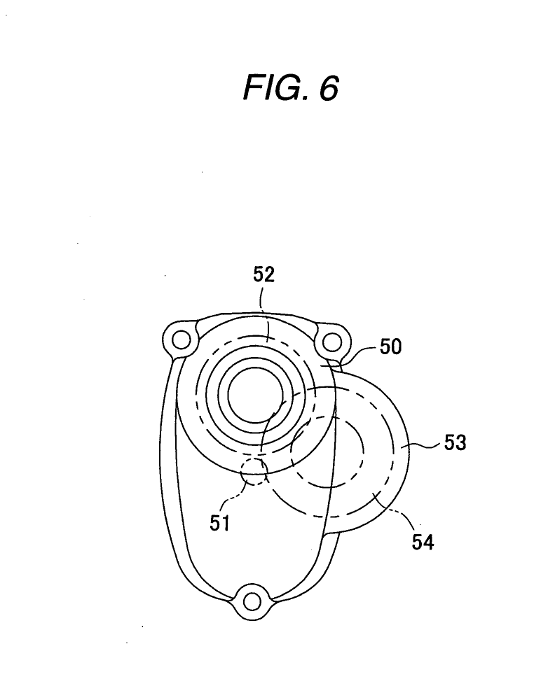

Alternatively, according to a second embodiment of the invention as shown in FIG. 4, a lever 36 having a pin 37 which is engaged with the groove 35 in the second gear 19 may be provided on the lower face of the tubular part 12 so as to slide in the front-rear direction, so that the front and rear positions of the second gear 19 can be selected by operating the lever 36 back and forth.

Further, according to a third embodiment of the invention as shown in FIG. 5, the second gear 19 may be urged by a coil spring 38 to the front position in which it comes into contact with a stopper 39 in the tubular part 12, while a knob 40 having a contact face (circumferential face) with the front face of the second gear 19 is rotatably fitted with a pin 41. The knob 40 is configured such that radius thereof varies in accordance with circumferential positions thereof so as to form a cam face. Thus, in accordance with the turn of the knob 40, the contact face can move the second gear 19 rearward against urging force of the coil spring 38, and when the knob 40 is turned in an opposite direction, the second gear 19 can move forward by the urging force of the coil spring 38.

Besides, the front housing is not limited to an assembly of a plurality of housings and sleeves as in the above described embodiment, but may be an integral body which is coupled to the main housing. The main housing too may be an integral body.

Moreover, manner of rotatably holding the clutch mechanism and the output shaft, and manner of mounting the driver bit etc. are not limited to the above described embodiment, but may be appropriately changed in design. The carrier provided with the planetary gears too is not limited to one step, but a plurality of steps may be provided coaxially. In this case, the second gear in either step may be provided so as to rotate and so as to move back and forth, so that it can be used for two-step speed change.

In the above embodiments, two-step speed changing mechanism is provided. However, it is possible to attain the advantageous aspect that a screw driver which is excellent in workability while a compact housing is realized even if the two-step speed changing mechanism is omitted. In such a configuration, the second gear 19 is fixed on the inner face of the front housing 5 under the state shown in FIG. 2.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

What is claimed is:

1. A screw driver, comprising:
a motor, having a motor shaft; an output shaft, provided with a driver bit and movable in an axial direction thereof;
a first gear, configured to rotate around a rotary center to transmit rotations of the motor shaft;
a second gear, having inner teeth; a carrier, including planetary gears each of which is disposed inside the second gear to mesh with the inner teeth; and
a clutch mechanism, configured to connect or disconnect the carrier and the output shaft in accordance with the movement of the output shaft wherein:
the rotations of the first gear is transmitted to the carrier by way of the planetary gears.

2. The screw driver as set forth in claim 1, further comprising:
a housing, having an inner face formed with an engagement member; and
an operating member, adapted to be manually operated, wherein:
the second gear is movable in the axial direction between a first position meshed with the first gear and a second position engaged with the engagement member by the operating member;
the second gear rotates around the rotary center together with the first gear and the planetary gears are not allowed to revolve around to revolve around the rotary center when the second gear is placed in the first position, so that the rotations of the first gear is directly transmitted to the carrier; and
the second gear is not allowed to rotate around the rotary center and the planetary gears are allowed to revolve around the rotary center when the second gear is placed in the second position, so that the rotations of the first gear is reduced and transmitted to the carrier by way of the planetary gears.

3. The screw driver as set forth in claim 2, wherein:
the operating member is a disk-shaped knob; and
the second gear is moved between the first position and the second position by turning the knob.

4. The screw driver as set forth in claim 3, further comprising:
a pin, formed on an inner face of the knob at an eccentric position relative to a turning center of the knob; and
the pin is fitted with a groove formed on a circumferential face of the second gear, so that the second gear is moved in accordance with the turn of the knob.

5. The screw driver as set forth in claim 3, further comprising:
an elastic member, urging the second gear toward one of the first position and the second position; and
a part of a circumferential face of the knob forms a cam face configured to move the second gear against an urging force of the elastic member in accordance with the turn of the knob.

6. The screw driver as set forth in claim 2, further comprising:
a pin, formed on an inner face of the operating member and fitted with a groove formed on a circumferential face of the second gear; and
the second gear is moved between the first position and the second position by moving the operating member in the axial direction.
